(19) United States
(12) Patent Application Publication
(10) Pub. No.: US 2016/0122886 A1
(43) Pub. Date: May 5, 2016

(54) ELECTRODE COMPOSITION, APPARATUS AND METHOD FOR REMOVING NITROGEN OXIDE

(71) Applicant: General Electric Company, Schenectady, NY (US)

(72) Inventors: Shizhong WANG, Shanghai (CN); Qunjian HUANG, Shanghai (CN); Xiao ZHANG, Shanghai (CN); Qijia FU, Shanghai (CN); Hai YANG, Shanghai (CN); Andrew SHAPIRO, Niskayuna, NY (US); Hua ZHANG, Greenville, SC (US)

(21) Appl. No.: 14/924,978

(22) Filed: Oct. 28, 2015

(30) Foreign Application Priority Data
Oct. 31, 2014 (CN) 201410605175.5

(51) Int. Cl. C25B 11/04; C25B 1/00; B01D 53/32; B01J 20/06; B01J 23/889

(52) U.S. Cl. CPC C25B 11/0478; B01J 20/06; B01J 23/8892; B01D 53/326; C25B 1/00; B01D 2259/818

(57) ABSTRACT

An electrode composition for removing nitrogen oxide, includes: a catalytic material and an adsorption material, wherein the adsorption material is a perovskite material of formula AₐB_{b}O_{3-δ}, wherein 0.9<a≦1.2; 0.9<b≦1.2; −0.5<δ<0.5; A comprises a first element and optionally a second element, the first element is selected from calcium, strontium, barium, lithium, sodium, potassium, rubidium, and any combination thereof, the second element is selected from yttrium, bismuth, lanthanum, cerium, praseodymium, neodymium, promethium, samarium, europium, gadolinium, terbium, dysprosium, holmium, erbium, thulium, ytterbium, lutetium, and any combination thereof; and B is selected from silver, gold, cadmium, cerium, cobalt, chromium, copper, dysprosium, erbium, europium, ferrum, gallium, gadolinium, hafnium, holmium, indium, iridium, lanthanum, lutetium, manganese, molybdenum, niobium, neodymium, nickel, osmium, palladium, promethium, praseodymium, platinum, rhenium, rhodium, ruthenium, antimony, scandium, samarium, tin, tantalum, terbium, technetium, titanium, thulium, vanadium, tungsten, yttrium, ytterbium, zinc, zirconium, and any combination thereof. An associated apparatus and method are also described.

### BACKGROUND OF THE INVENTION

Embodiments of the present invention relate generally to electrode compositions, apparatuses and methods for removing nitrogen oxide.

Nitrogen oxide (NOₓ, including NO and/or NO₂) is undesirable for the environment and thus industry has considered and implemented various techniques to reduce NOₓ emissions. Some approaches have been proposed to electrochemically reduce nitrogen oxide. However, currently available electrode compositions, apparatuses and methods still need improvements.

Therefore, it is desirable to provide new electrode compositions, apparatuses and methods for removing nitrogen oxide.

### BRIEF DESCRIPTION

In one aspect, embodiments of the invention relate to an electrode composition for removing nitrogen oxide, comprising: a catalytic material and an adsorption material, wherein the adsorption material is a perovskite material of formula AₐB_{b}O_{3-δ}, wherein 0.9<a≦1.2; 0.9<b≦1.2; −0.5<δ<0.5; A comprises a first element and optionally a second element, the first element is selected from calcium (Ca), strontium (Sr), barium (Ba), lithium (Li), sodium (Na), potassium (K), rubidium (Rb), and any combination thereof, the second element is selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and any combination thereof; and B is selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), zirconium (Zr), and any combination thereof.

In another aspect, embodiments of the invention relate to an apparatus for removing nitrogen oxide, comprising: a gas source for providing a gas stream comprising nitrogen oxide; and a device in fluid communication with the gas source and comprising: a first electrode; an opposite second electrode comprising a catalytic material and an adsorption material, wherein the adsorption material is a perovskite material of formula AₐB_{b}O_{3-δ}, wherein 0.9<a≦1.2, 0.9<b≦1.2, −0.5<δ<0.5, A comprises a first element and optionally a second element, the first element is selected from calcium (Ca), strontium (Sr), barium (Ba), lithium (Li), sodium (Na), potassium (K), rubidium (Rb), and any combination thereof, the second element is selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and any combination thereof, and B is selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), zirconium (Zr), and any combination thereof; an electrolyte (103, 203, 303, 403) between the first and the second electrodes; and a power supply (104, 204, 304, 404) for applying an electrical current to the first and the second electrodes to remove nitrogen oxide.

In yet another aspect, embodiments of the invention relate to a method for removing nitrogen oxide, comprising: contacting a gas stream comprising nitrogen oxide with a device, the device comprising: a first electrode; an opposite second electrode comprising a catalytic material and an adsorption material; an electrolyte between the first and the second electrodes; and, a power supply; and applying an electrical current from the power supply to the first and the second electrodes to remove nitrogen oxide; wherein the adsorption material is a perovskite material of formula AₐB_{b}O_{3-δ}, wherein 0.9<a≦1.2; 0.9<b≦1.2; −0.5<δ<0.5; A comprises a first element and optionally a second element, the first element is selected from calcium (Ca), strontium (Sr), barium (Ba), lithium (Li), sodium (Na), potassium (K), rubidium (Rb), and any combination thereof, and the second element is selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and any combination thereof and B is selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), zirconium (Zr), and any combination thereof.

### BRIEF DESCRIPTION OF THE DRAWINGS

These and other features, aspects, and advantages of the present invention will become better understood when the following detailed description is read with reference to the accompanying drawings, wherein:

FIGS. 1, 2, 3 and 4 illustrate schematic cross sectional views of apparatuses according to embodiments of the present invention;

FIG. 5 shows the intensity of NO signal (arbitrary unit) at different temperatures in the exhaust stream from the thermo gravimetric analyzer (TGA) respectively with BaZr_{0.1}Ce_{0.7}Y_{0.2}O₃ powder and carbon black;

FIGS. 6 and 7 illustrate the intensities of NO signal (arbitrary unit) at different temperatures in the exhaust streams from the TGA with Ba_{0.5}Sr_{0.4}K_{0.1}Co_{0.8}Fe_{0.2}O₃ powder, and the mixtures of carbon black respectively with Ba_{0.5}Sr_{0.5}Co_{0.8}Fe_{0.2}O₃ powder, Ba_{0.5}Sr_{0.4}K_{0.1}Co_{0.8}Fe_{0.2}O₃ powder, and Ba_{0.9}K_{0.1}Zr_{0.3}Ce_{0.5}Co_{0.1}Y_{0.1}O₃ powder;

FIG. 8 shows the NO conversion percentage of a gas stream (200 ml/min, 20 ppm NO balanced with He) in reactors respectively using a La_{0.6}Sr_{0.4}Ni_{0.3}Mn_{0.7}O₃ and Zr_{0.89}Sc_{0.1}Ce_{0.01}O₂₋ₓ layer, a La_{0.6}Sr_{0.4}Ni_{0.3}Mn_{0.7}O₃, Zr_{0.89}Sc_{0.1}Ce_{0.01}O₂₋ₓ and BaZr_{0.1}Ce_{0.7}Y_{0.2}O₃ layer, and a Zr_{0.89}Sc_{0.1}Ce_{0.01}O₂₋ₓ and BaZr_{0.1}Ce_{0.7}Y_{0.2}O₃ layer as cathodes at 600° C. as a function of electric current; and

FIG. 9 shows the NO conversion percentage of a gas stream (200 ml/min, 20 ppm NO, 2000 ppm O₂, balanced with He) at 600° C. in reactors respectively using a La_{0.6}Sr_{0.4}Ni_{0.3}Mn_{0.7}O₃ and Zr_{0.89}Sc_{0.1}Ce_{0.01}O₂₋ₓ layer, a La_{0.6}Sr_{0.4}Ni_{0.3}Mn_{0.7}O₃, Zr_{0.89}Sc_{0.1}Ce_{0.01}O₂₋ₓ and BaZr_{0.1}Ce_{0.7}Y_{0.2}O₃ layer, and a Zr_{0.89}Sc_{0.1}Ce_{0.01}O₂₋ₓ and BaZr_{0.1}Ce_{0.7}Y_{0.2}O₃ layer as cathodes at 600° C. as a function of electric current.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. The use of “including”, “comprising” or “having” and variations thereof herein are meant to encompass the items listed thereafter and equivalents thereof as well as additional items.

Approximating language, as used herein throughout the specification and claims, may be applied to modify any quantitative representation that could permissibly vary without resulting in a change in the basic function to which it is related. Accordingly, a value modified by a term or terms, such as “about” is not to be limited to the precise value specified. In some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

In the specification and the claims, the singular forms “a”, “an” and “the” include plural referents unless the context clearly dictates otherwise. Moreover, the suffix “(s)” as used herein is usually intended to include both the singular and the plural of the term that it modifies, thereby including one or more of that term.

As used herein, the term “or” is not meant to be exclusive and refers to at least one of the referenced components (for example, a material) being present and includes instances in which a combination of the referenced components may be present, unless the context clearly dictates otherwise.

Reference throughout the specification to “some embodiments”, and so forth, means that a particular element (e.g., feature, structure, and/or characteristic) described in connection with the invention is included in at least one embodiment described herein, and may or may not be present in other embodiments. In addition, it is to be understood that the described inventive features may be combined in any suitable manner in the various embodiments.

Embodiments of the present invention relate to electrode compositions, apparatuses and methods for removing nitrogen oxide.

As used herein the term “nitrogen oxide” or the like refers to a gas comprising molecules including both oxygen and nitrogen, for example, nitrogen monoxide, nitrogen dioxide, or a combination thereof.

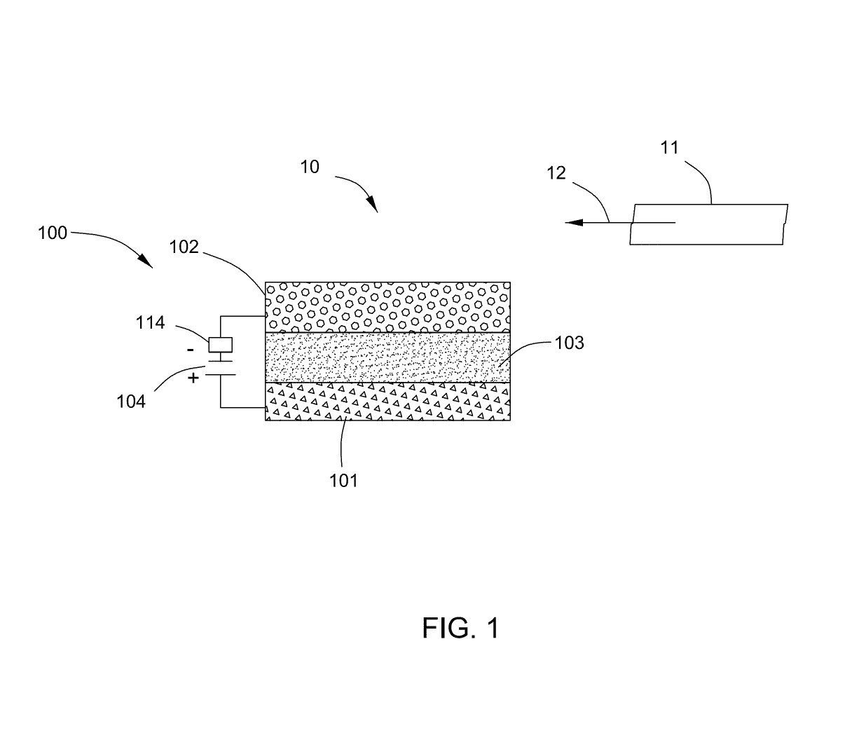

Please refer to FIGS. 1, 2, 3 and 4, an apparatus 10, 20, 30, 40 of embodiments of the invention includes a gas source 11, 21, 31, 41 for providing a gas stream 12, 22, 32, 42 comprising nitrogen oxide and a device 100, 200, 300, 400 in fluid communication with the gas source 11, 21, 31, 41.

The gas stream comprising nitrogen oxide may be from a variety of gas sources. In some embodiments, the gas sources are exhaust gas sources from gas turbines, internal combustion engines, or combustion devices. In some embodiments, the gas source comprises a conduit, a channel, or a tube for the passage of the gas stream. In some embodiments, besides nitrogen oxide, the gas stream 12, 22, 32, 42 comprises other gases, such as oxygen.

In some embodiments, the device 100, 200, 300, 400 includes a first electrode 101, 201, 301, 401, an opposite second electrode 102, 202, 302, 402, an electrolyte 103, 203, 303, 403 between the first and the second electrodes, and a power supply 104, 204, 304, 404 for applying an electrical current from the power supply 104, 204, 304, 404 to the first and the second electrodes to remove nitrogen oxide. In some embodiments, the powder supply 104, 204, 304, 404 has a controller 114, 214, 314, 414 for controlling the electrical current.

In some embodiments, nitrogen oxide can be directly decomposed in the device 100, 200, 300, 400 before an electrical current is applied. When a gas stream 12, 22, 32, 42 comprising nitrogen oxide is contacted with the device 100, 200, 300, 400, nitrogen oxide is removed in the second electrode 102, 202, 302, 402 in a reaction such as: NO=½N₂+½O₂.

However, as can be seen from examples described hereafter, when the electrical current is applied, besides the direct decomposition of NO described above, nitrogen oxide is removed in the cathode in an electrochemical reaction of NO+2e→½N₂+O²⁻. The oxygen ions produced thereby travel from the cathode through the electrolyte into the anode to be oxidized into oxygen in a reaction of O²⁻-2e→½O₂. A total reaction in the device is: NO=½N₂+½O₂. The removal rate of nitrogen oxide is increased.

The removal of nitrogen oxide may be at any suitable temperature. In some embodiments, the step of applying the electrical current is at a temperature in a range from about 300° C. to about 1000° C.

The electrical current may be any electrical current that can be used to decompose nitrogen oxide at a conversion rate higher than that of before an electrical current is applied. In some embodiments, the electrical current is direct current. In some embodiments, the electrical current is applied by jumping to the designed value directly. In some embodiments, the electrical current is applied by sweeping to the designed value slowly.

The controller 114, 214, 314, 414 may be any mechanism that controls the on and off and/or increasing and decreasing of the electrical current. In some embodiments, the controller is a switch for turning on and off the electrical current.

In some embodiments, the first electrode 101, 201, 301, 401 is an anode. The anode may include any material that catalyzes the oxidization of oxygen ions to oxygen, and any other materials that can be used in the anode. In some embodiments, the anode comprises a manganite, such as lanthanum strontium manganite (LSM), a non-limiting exemplary composition of which includes (La_{0.8}Sr_{0.2})_{0.95}MnO₃; a combination of platinum and yttria stabilized zirconia; a combination of platinum and gadolinium-doped ceria; or any combination thereof.

In some embodiments, the second electrode 102, 202, 302, 402 is a cathode. Besides the catalytic material and the adsorption material, the electrode composition of the second electrode 102, 202, 302, 402 may have any other materials that can be used in the cathode. As can be seen from examples incorporated hereafter, the adsorption material according to embodiments of the present invention significantly improved the removal rate of nitrogen oxide.

The catalytic material may be any material that catalyzes the decomposition of nitrogen oxide. In some embodiments, the catalytic material comprises a manganite, such as lanthanum strontium nickel manganite (LSNM), an exemplary composition of which includes, but is not limited to, La_{0.6}Sr_{0.4}Ni_{0.3}Mn_{0.7}O₃; nickel oxide (NiO); a combination of LSNM and gadolinium doped ceria (GDC, e.g., Gd_{0.1}Ce_{0.9}O_{1.95}); a combination of LSNM and scandia stabilized zirconia (SSZ, e.g., Zr_{0.89}Sc_{0.1}Ce_{0.01}O₂₋ₓ); a combination of LSNM, NiO and SSZ; a combination of NiO and SSZ; a combination of platinum with yttria-stabilized zirconia; a combination of platinum with GDC; or any combination thereof.

The adsorption material adsorbs nitrogen oxide. As used herein the term “perovskite material” or any variation thereof refers to but is not limited to any material having an ABO₃ perovskite structure and being of formula AₐB_{b}O_{3-δ}, wherein 0.9<a≦1.2; 0.9<b≦1.2; −0.5<δ<0.5; A comprises a first element and optionally a second element, the first element is selected from calcium (Ca), strontium (Sr), barium (Ba), lithium (Li), sodium (Na), potassium (K), rubidium (Rb) and any combination thereof, the second element is selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu) and any combination thereof; and B is selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), zirconium (Zr), and any combination thereof.

In some embodiments, the perovskite material may be of formula n(AₐB_{b}O_{3-δ}), in which n=2, 3, 4, 8, and etc., and the formula AₐB_{b}O_{3-δ} is the simplified form thereof.

In some embodiments, in the ABO₃ perovskite structure, A cations are surrounded by twelve anions in cubo-octahedral coordination, B cations are surrounded by six anions in octahedral coordination and oxygen anions are coordinated by two B cations and four A cations. In some embodiments, the ABO₃ perovskite structure is built from corner-sharing BO₆ octahedra. In some embodiments, the ABO₃ perovskite structure includes distorted derivatives. The distortions may be due to rotation or tilting of regular, rigid octahedra or due to the presence of distorted BO₆ octahedra. In some embodiments, the ABO₃ perovskite structure is cubic. In some embodiments, the ABO₃ perovskite structure is hexagonal.

In some embodiments, A only comprises the first element. In some embodiments, A comprises a combination of the first element and the second element.

In some embodiments, the first element is selected from potassium (K), barium (Ba), strontium (Sr), and any combination thereof.

The second element may be a single element or a combination of elements selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

Likewise, B may be a single element or a combination of elements selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), and zirconium (Zr). In some embodiments, B is selected from yttrium (Y), cobalt (Co), cerium (Ce), zirconium (Zr), ferrum (Fe), and any combination thereof.

In some embodiments, the perovskite material comprises BaZr_{0.1}Ce_{0.7}Y_{0.2}O₃, Ba_{0.5}Sr_{0.5}Co_{0.8}Fe_{0.2}O₃, Ba_{0.5}Sr_{0.4}K_{0.1}Co_{0.8}Fe_{0.2}O₃, Ba_{0.9}K_{0.1}Zr_{0.3}Ce_{0.5}Co_{0.1}Y_{0.1}O₃, or any combination thereof. For example, for BaZr_{0.1}Ce_{0.7}Y_{0.2}O₃, A is Ba, a=1, B is a combination of Zr, Ce and Y, b=1, and δ=0. For Ba_{0.5}Sr_{0.5}Co_{0.8}Fe_{0.2}O₃, A is a combination of Ba and Sr, a=1, B is a combination of Co and Fe, b=1, and δ=0. For Ba_{0.5}Sr_{0.4}K_{0.1}Co_{0.8}Fe_{0.2}O₃, A is a combination of Ba, Sr and K, a=1, B is a combination of Co and Fe, b=1, and δ=0. For Ba_{0.9}K_{0.1}Zr_{0.3}Ce_{0.5}Co_{0.1}Y_{0.1}O₃, A is a combination of Ba and K, a=1, B is a combination of Zr, Ce, Co and Y, b=1, and δ=0.

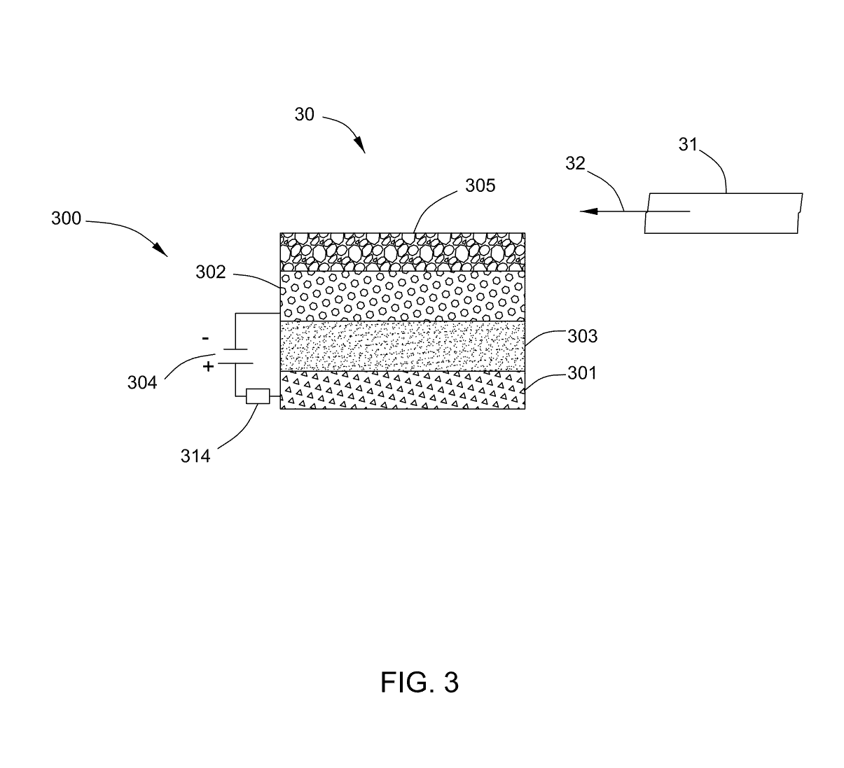

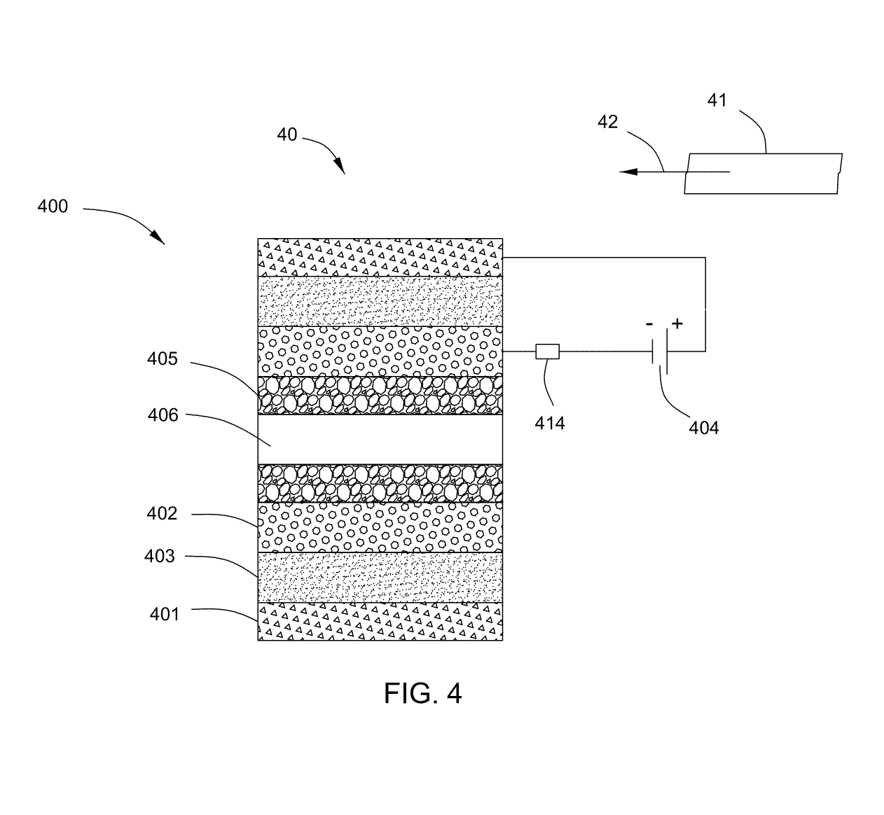

In some embodiments, as is shown in FIGS. 3 and 4, the apparatus 30, 40 comprises an adsorption layer 305, 405 disposed over the second electrode 302, 402, either directly, or with one or more intermediate layers therebetween. The adsorption layer comprises the adsorption material such as those described previously. In such embodiments, the apparatus 30, 40 has a layer 302, 402 comprising the catalytic material and a layer 305, 405 comprising the adsorption material. The adsorption material may be distributed inside the cathode without forming an extra layer separated from the layer comprising the catalytic material. In such embodiments, the apparatus 10, 20 has a layer 102, 202 comprising the catalytic material and the adsorption material.

In some embodiments, the apparatus comprises a current collector (not shown). The current collector may be made of any electrically conductive materials such as metals or metal alloys and be in any forms suitable for use in supplying or withdrawing electrical current from the electrodes. In some embodiments, the current collector is made of nickel. In some embodiments, the current collector is in the form of mesh, porous film, foam, or any combination thereof. In some embodiments, the current collector is nickel foam. In some embodiments, a porosity of a porous metallic current collector is in a range from about 25% to about 99%.

In some embodiments, the current collector is a mechanical support for the first and the second electrodes.

In some embodiments, the current collector is disposed over the second electrode, either directly, or with one or more intermediate layers therebetween.

The electrolyte may include any material that has a suitable level of oxygen ion conductivity and any other suitable material. In some embodiments, the electrolyte comprises GDC, such as Gd_{0.1}Ce_{0.9}O_{1.95}; SSZ, such as Zr_{0.89}Sc_{0.1}Ce_{0.01}O₂₋ₓ; oxide materials from the barium-zirconium-cerium-yttrium (BZCY) family, such as BaZr_{0.7}Ce_{0.2}Y_{0.1}O₃; or any combination thereof. In some embodiments, the electrolyte includes bismuth oxide, zeolite, alumina, silica, aluminum nitride, SiC, nickel oxide, iron oxide, copper oxide, calcium oxide, magnesium oxide, zinc oxide, aluminum, yttria stabilized zirconia, scandia stabilized zirconia, perovskite oxides, lanthanum strontium calcium manganese, lanthanum silicate, Nd_{9.33}(SiO₄)₆O₂, AlPO₄, B₂O₃, and R₂O (R stands for an alkaline metal), AlPO₄—B₂O₃—R₂O glass which carries out the main component of Na and the K, porous SiO₂—P₂O₅ system glass, Y addition BaZrO₃, Y addition SrZrO₃ and Y addition SrTiO₃, strontium doping lanthanum manganite, a lanthanum strontium cobalt iron oxide (La—Sr—Co—Fe system perovskite type oxide), a La—Sr—Mn—Fe system perovskite type oxide, a Ba—Sr—Mn—Fe system perovskite type oxide, or any combination thereof.

A dense electrolyte is preferred for mitigating the mixing of the gases of the cathode and the anode and reducing the ohmic resistance of the electrolyte. Low ohmic resistance is preferred for energy saving in the NOx removal process.

Each of the electrode, the electrolyte, the current collector, and the adsorption layer may be a single layer or comprise more than one layer depending on the needed flexibility, gas diffusion capability, and porosity. Multiple layers may be the same as or different from each other and connected in suitable ways. In each single layer, the composition may be the same or different through at least one dimension thereof.

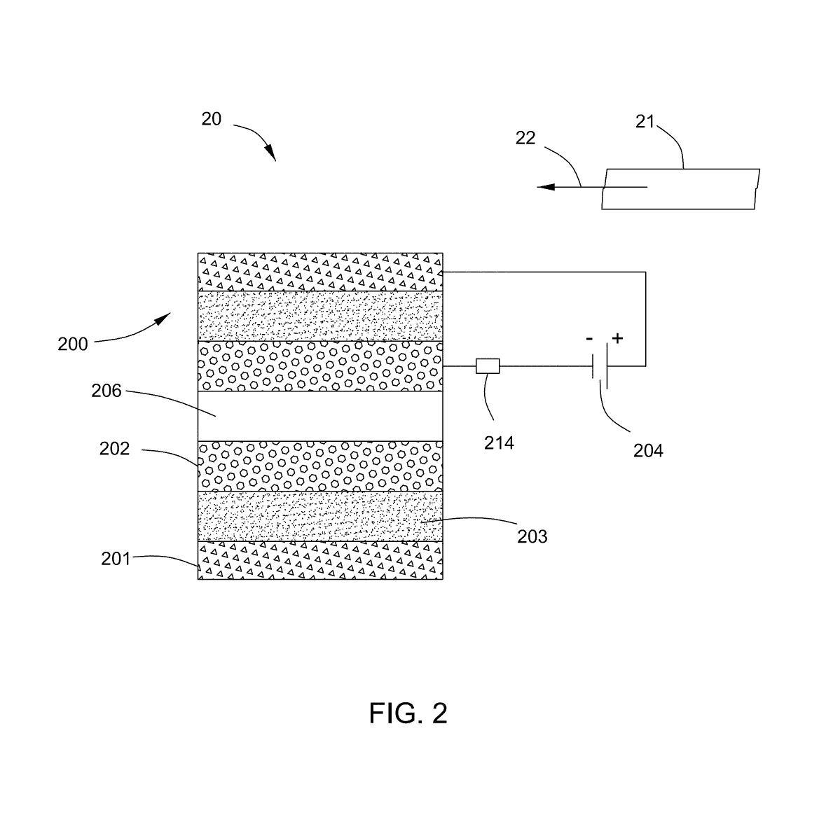

The apparatus may be of any configuration suitable for removing nitrogen oxide. In some embodiments, as is shown in FIGS. 1 and 3, the device 100, 300 is of a planar configuration. In some embodiments, as is shown in FIGS. 2 and 4, the device 200, 400 is of a tubular configuration and comprises a space 206, 406 therein.

The device described herein may be prepared by providing a current collector and applying sequentially different layers on both sides thereof, or providing any of other layers and laminating different layers on either/both sides thereof. The layers may be formed/applied/laminated by any suitable means such as extruding, dip coating, spraying and printing.

### EXAMPLES

The following examples are included to provide additional guidance to those of ordinary skill in the art in practicing the claimed invention. These examples do not limit the invention as defined in the appended claims.

### EXAMPLE 1

### La_{0.6}Sr_{0.4}Ni_{0.3}Mn_{0.7}O₃ Synthesis

La₂O₃, SrCO₃, Mn(AC)₂.4H₂O and NiO were ball milled in EtOH and calcined at 1300° C. for 8 hours to prepare La_{0.6}Sr_{0.4}Ni_{0.3}Mn_{0.7}O₃. X-ray diffraction (XRD) analyses confirmed that a pure phase of La_{0.6}Sr_{0.4}Ni_{0.3}Mn_{0.7}O₃ was obtained.

### EXAMPLE 2

### BaZr_{0.1}Ce_{0.7}Y_{0.2}O₃ Powder Preparation

The BaZr_{0.1}Ce_{0.7}Y_{0.2}O₃ powder was prepared by solid-state reaction method. Stoichiometric amounts of high-purity barium carbonate, zirconium oxide, yttrium oxide, and cerium oxide powders (all from sinopharm chemical reagent Co., Ltd. (SCRC), Shanghai, China) were mixed in ethanol and ball-milled for about 16 hours. The resultant mixtures were then dried and calcined at about 1450° C. in air for about 6 hours to form the BaZr_{0.1}Ce_{0.7}Y_{0.2}O₃ powder. The calcined powder was mixed with alcohol and was ball milled for about 16 hours. After the alcohol was dried, fine BaZr_{0.1}Ce_{0.7}Y_{0.2}O₃ powder (d₅₀=1.5 micron) was prepared.

### EXAMPLE 3

### Adsorption Test

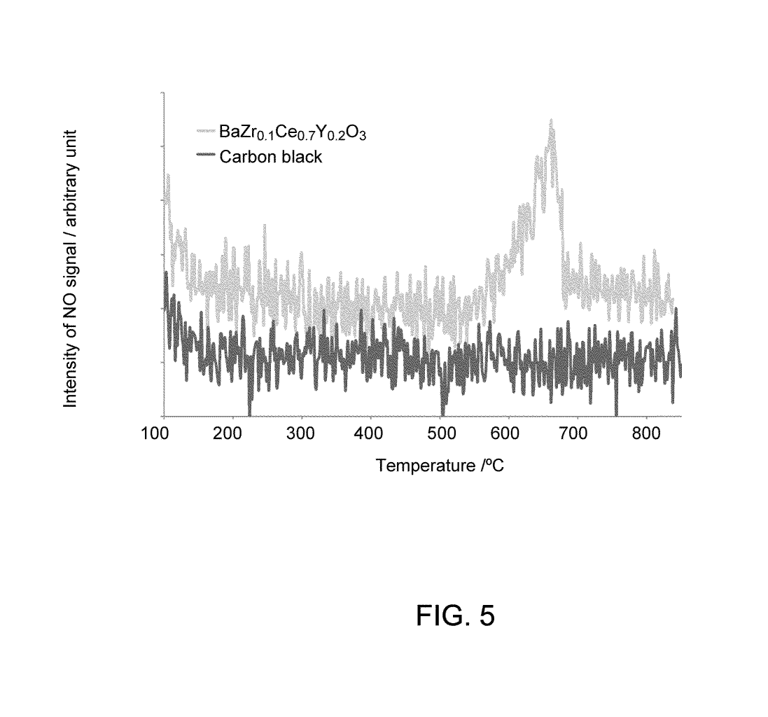

BaZr_{0.1}Ce_{0.7}Y_{0.2}O₃ powder and carbon black were respectively put into a thermo gravimetric analyzer (TGA) in a 200 ml/min gas stream comprising 100 ppm NO and 16% O₂, and balanced with N₂. The temperature ramped up at 5° C./min to 850° C. A mass spectrometer (HPR20, Hiden Analytical, Warrington, UK) was coupled with the TGA to monitor NO/NO₂ in the exhaust from the TGA. The intensity of NO signals (arbitrary unit) at different temperatures in the exhaust from the TGA respectively with BaZr_{0.1}Ce_{0.7}Y_{0.2}O₃ powder and carbon black are shown in FIG. 5.

FIG. 5 shows that there was an obvious peak of the intensities of NO signals of the exhaust stream from the TGA with BaZr_{0.1}Ce_{0.7}Y_{0.2}O₃ powder but no obvious peak of the exhaust stream from the TGA with carbon black, which indicate that nitrogen oxide (NO/NO₂) was absorbed and desorbed by BaZr_{0.1}Ce_{0.7}Y_{0.2}O₃ powder, but was not absorbed and desorbed by carbon black.

### EXAMPLE 4

### Adsorption Test

Ba_{0.5}Sr_{0.5}Co_{0.8}Fe_{0.2}O₃ powder, Ba_{0.5}Sr_{0.4}K_{0.1}Co_{0.8}Fe_{0.2}O₃ powder and Ba_{0.9}K_{0.1}Zr_{0.3}Co_{0.5}Co_{0.1}Y_{0.1}O₃ powder were prepared in similar ways as that of BaZr_{0.1}Ce_{0.7}Y_{0.2}O₃ powder described in example 2.

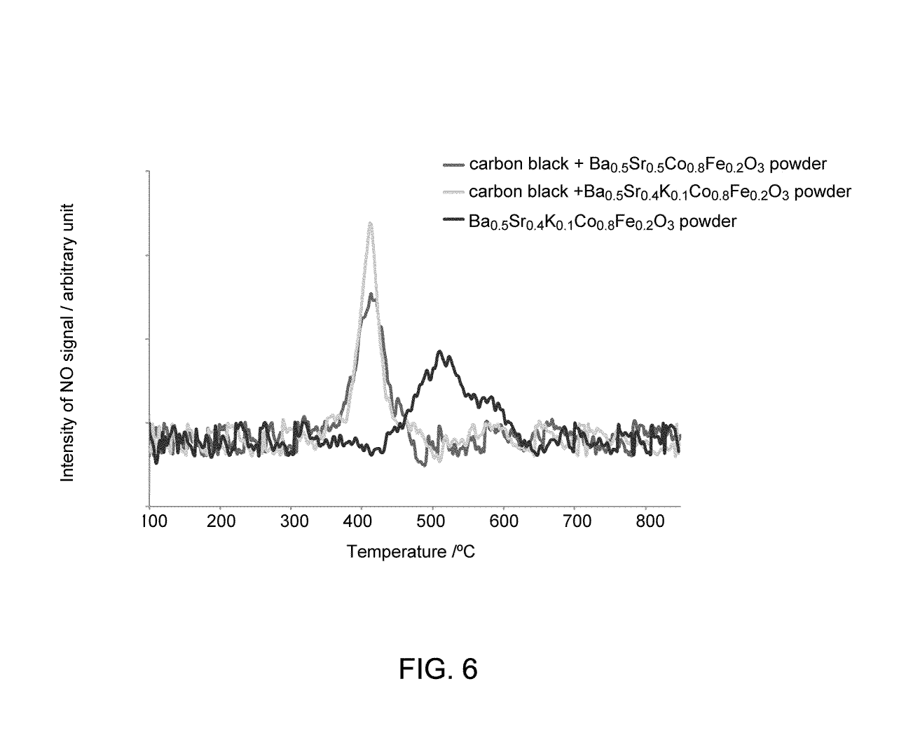

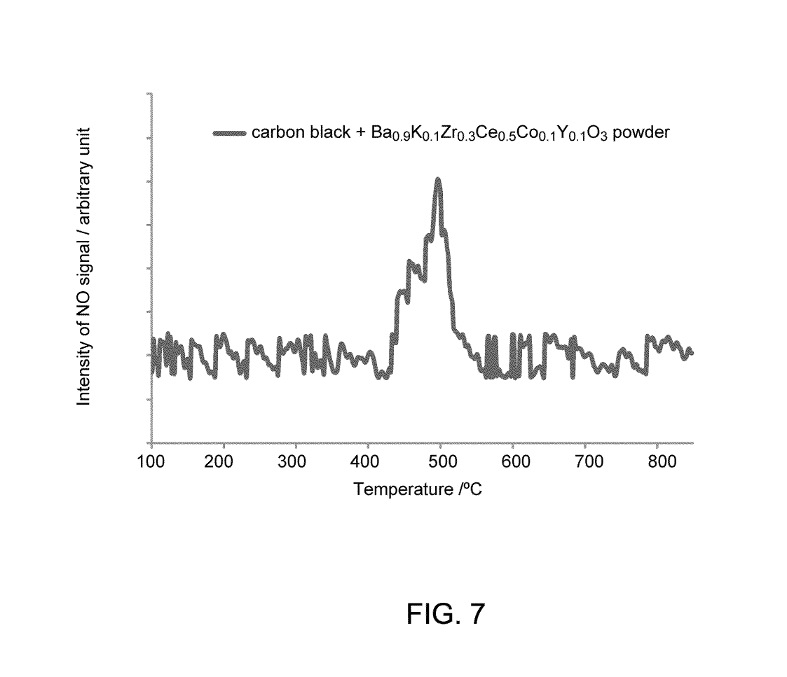

Ba_{0.5}Sr_{0.5}Co_{0.8}Fe_{0.2}O₃ powder, Ba_{0.5}Sr_{0.4}K_{0.1}Co_{0.8}Fe_{0.2}O₃ powder, and Ba_{0.9}K_{0.1}Zr_{0.3}Ce_{0.5}Co_{0.1}N_{0.1}O₃ powder (20 mg) were respectively mixed with 2 mg carbon black and put into a thermo gravimetric analyzer (TGA) in a 200 ml/min gas stream comprising 100 ppm NO and 16% O₂, and balanced with N₂. The temperature ramped up at 5° C./min to 850° C. A mass spectrometer (HPR20, Hiden Analytical, Warrington, UK) was coupled with the TGA to monitor NO/NO₂ in the exhaust stream from the TGA. The intensities of NO signals at different temperatures in the exhaust streams from the TGA with the mixtures of carbon black respectively with Ba_{0.5}Sr_{0.5}Co_{0.8}Fe_{0.2}O₃ powder, Ba_{0.5}Sr_{0.4}K_{0.1}Co_{0.8}Fe_{0.2}O₃ powder, and Ba_{0.9}K_{0.1}Zr_{0.3}Ce_{0.5}Co_{0.1}N_{0.1}O₃ powder are shown in FIGS. 6-7. As a comparison, the intensity of NO signal (arbitrary unit) at different temperatures in the exhaust stream from the TGA with Ba_{0.5}Sr_{0.4}K_{0.1}Co_{0.8}Fe_{0.2}O₃ was also shown in FIG. 6.

FIGS. 6-7 show that there were peaks of intensities of NO, which indicate that nitrogen oxide (NO/NO₂) were absorbed and desorbed by Ba_{0.5}Sr_{0.5}Co_{0.8}Fe_{0.2}O₃ powder, Ba_{0.5}Sr_{0.4}K_{0.1}Co_{0.8}Fe_{0.2}O₃ powder, and Ba_{0.9}K_{0.1}Zr_{0.3}Co_{0.5}Co_{0.1}N_{0.1}O₃ powder. FIG. 6 shows that carbon black makes the NOx desorption more obvious at relatively lower temperatures possibly due to the reduction of adsorbed species, which is typically in the reversible state of surface nitrate.

### EXAMPLE 5

### Reactor Preparation

Three 7.5 cm long one-end open (La_{0.8}Sr_{0.2})_{0.95}MnO₃ tubes were fabricated by extruding. The outer diameter of each tube was about 1 cm, and the inner diameter was about 0.7 cm.

A dense Zr_{0.89}Sc_{0.1}Ce_{0.01}O₂₋ₓ electrolyte film was coated on each (La_{0.8}Sr_{0.2})_{0.95}MnO₃ tube and was co-sintered with the (La_{0.8}Sr_{0.2})_{0.95}MnO₃ tube at 1250° C.

A layer of La_{0.6}Sr_{0.4}Ni_{0.3}Mn_{0.7}O₃, BaZr_{0.1}Ce_{0.7}Y_{0.2}O₃ and Zr_{0.89}Sc_{0.1}Ce_{0.01}O₂₋ₓ (La_{0.6}Sr_{0.4}Ni_{0.3}Mn_{0.7}O₃—BaZr_{0.1}Ce_{0.7}Y_{0.2}O₃—Zr_{0.89}Sc_{0.1}Ce_{0.01}O₂₋ₓ layer, 40 wt %, 30 wt %, and 30 wt %), a layer of La_{0.6}Sr_{0.4}Ni_{0.3}Mn_{0.7}O₃ and Zr_{0.89}Sc_{0.1}Ce_{0.01}O₂₋ₓ (La_{0.6}Sr_{0.4}Ni_{0.3}Mn_{0.7}O₃—Zr_{0.89}Sc_{0.1}Ce_{0.01}O₂₋ₓ layer, 50 wt % ratio) and a layer of BaZr_{0.1}Ce_{0.7}Y_{0.2}O₃ and Zr_{0.89}Sc_{0.1}Ce_{0.01}O₂₋ₓ (BaZr_{0.1}Ce_{0.7}Y_{0.2}O₃—Zr_{0.89}Sc_{0.1}Ce_{0.01}O₂₋ₓ layer, 50 wt % ratio) were respectively deposited on the Zr_{0.89}Sc_{0.1}Ce_{0.01}O₂₋ₓ electrolyte films and sintered at around 900° C. to 1100° C. to obtain three reactors. The active area of each of the La_{0.6}Sr_{0.4}Ni_{0.3}Mn_{0.7}O₃—BaZr_{0.1}Ce_{0.7}Y_{0.2}O₃ layer, the La_{0.6}Sr_{0.4}Ni_{0.3}Mn_{0.7}O₃ layer and the BaZr_{0.1}Ce_{0.7}Y_{0.2}O₃ layer was about 10 cm².

A layer of porous platinum paste was applied to each of the La_{0.6}Sr_{0.4}Ni_{0.3}Mn_{0.7}O₃—BaZr_{0.1}Ce_{0.7}Y_{0.2}O₃—Zr_{0.89}Sc_{0.1}Ce_{0.01}O₂₋ₓ layer, the La_{0.6}Sr_{0.4}Ni_{0.3}Mn_{0.7}O₃—Zr_{0.89}Sc_{0.1}Ce_{0.01}O₂₋ₓ layer and the BaZr_{0.1}Ce_{0.7}Y_{0.2}O₃—Zr_{0.89}Sc_{0.1}Ce_{0.01}O₂₋ₓ layer to form a porous metallic current collector of each reactor.

### EXAMPLE 6

### Removal of Nitrogen Oxide

The reactors were each put inside an alumina tube. The inner diameter of the alumina tube was about 2 cm. A gas stream (20 ppm NO balanced with He, 200 ml/min; or 20 ppm NO and 2,000 ppm O₂ balanced with He, 200 ml/min) was fed into the alumina tube passing through the outer surface of the reactor at a temperature of 600° C. Direct current (DC) was applied on each reactor for about 900 minutes and increased from 0 to 50 mA for the gas stream without oxygen or to 200 mA for the gas stream with oxygen.

The La_{0.6}Sr_{0.4}Ni_{0.3}Mn_{0.7}O₃—BaZr_{0.1}Ce_{0.7}Y_{0.2}O₃—Zr_{0.89}Sc_{0.1}Ce_{0.01}O₂₋ₓ layer, the La_{0.6}Sr_{0.4}Ni_{0.3}Mn_{0.7}O₃—Zr_{0.89}Sc_{0.1}Ce_{0.01}O₂₋ₓ layer and the BaZr_{0.1}Ce_{0.7}Y_{0.2}O₃—Zr_{0.89}Sc_{0.1}Ce_{0.01}O₂₋ₓ layer were assigned as cathodes, where the direct decomposition of NO and electrochemical NO reduction took place. The (La_{0.8}Sr_{0.2})_{0.95}MnO₃ layer was the anode, where the oxidation of oxygen ions took place. The corresponding voltage between anode and cathode was in the range of from 1 V to 1.5 V. Gas chromatography equipped with a PQ column and a RAE7800 gas sensor were used to detect NO and NO₂ in the exhaust stream from the reactors with an accuracy of 1 ppm and 0.1 ppm, respectively. NO₂ was not detected. The NO removal rate (conversion percentage) was calculated using the following formula: (NO volume in the gas stream-NO volume in the exhaust stream)/NO volume in the gas stream×100%.

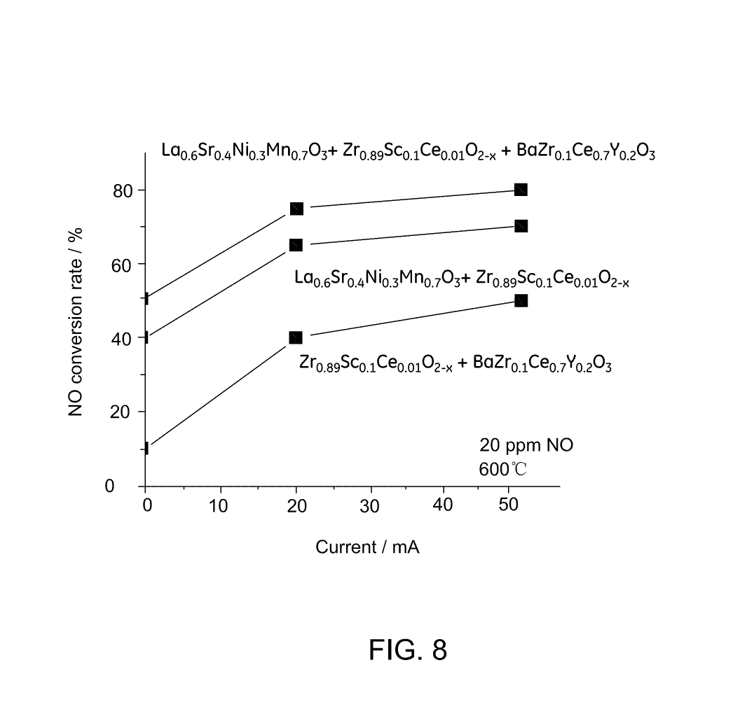

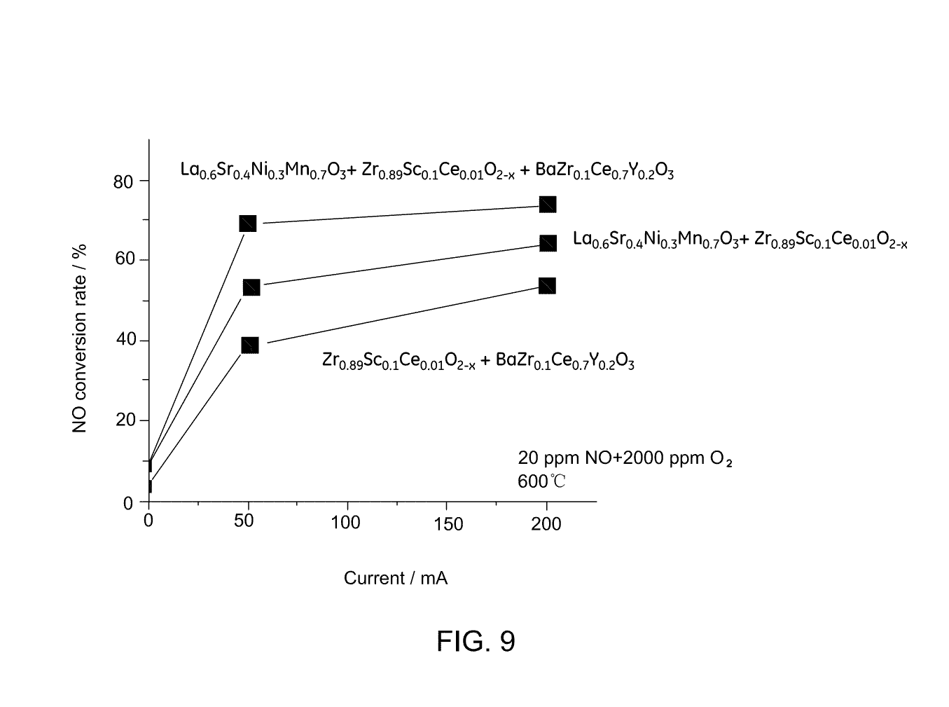

FIGS. 8 and 9 respectively show the NO conversion percentages of the gas stream (20 ppm NO balanced with He, 200 ml/min; or 20 ppm NO and 2,000 ppm O₂ balanced with He, 200 ml/min) in the reactors using La_{0.6}Sr_{0.4}Ni_{0.3}Mn_{0.7}O₃—BaZr_{0.1}Ce_{0.7}Y_{0.2}O₃—Zr_{0.89}Sc_{0.1}Ce_{0.01}O₂₋ₓ layer, the La_{0.6}Sr_{0.4}Ni_{0.3}Mn_{0.7}O₃—Zr_{0.89}Sc_{0.1}Ce_{0.01}O₂₋ₓ layer and the BaZr_{0.1}Ce_{0.7}Y_{0.2}O₃—Zr_{0.89}Sc_{0.1}Ce_{0.01}O₂₋ₓ layer as the cathode layers at 600° C. increased with the increase of the direct current. The NO conversion rate before applying the DC is the direct catalytic NOx decomposition activity of the reactor.

It can be seen from FIGS. 8 and 9 that BaZr_{0.1}Ce_{0.7}Y_{0.2}O₃ is not an ideal material for use as a catalytic material in the cathode, but as an adsorption material significantly increased NO conversion rates and the performance of the reactor with BaZr_{0.1}Ce_{0.7}Y_{0.2}O₃ was less dependent on oxygen compared with the reactor without BaZr_{0.1}Ce_{0.7}Y_{0.2}O₃.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. An electrode composition for removing nitrogen oxide, comprising:
a catalytic material and an adsorption material, wherein
the adsorption material is a perovskite material of formula AₐB_{b}O_{3-δ}, wherein
0.9<a≦1.2;
0.9<b≦1.2;
−0.5<δ<0.5;
A comprises a first element and optionally a second element, the first element is selected from calcium (Ca), strontium (Sr), barium (Ba), lithium (Li), sodium (Na), potassium (K), rubidium (Rb), and any combination thereof, the second element is selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and any combination thereof; and
B is selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), zirconium (Zr), and any combination thereof.

2. The electrode composition of claim 1, wherein the first element is selected from potassium (K), barium (Ba), strontium (Sr), and any combination thereof.

3. The electrode composition of claim 1, wherein B is selected from yttrium (Y), cobalt (Co), cerium (Ce), zirconium (Zr), ferrum (Fe), and any combination thereof.

4. An apparatus for removing nitrogen oxide, comprising:
a gas source for providing a gas stream comprising nitrogen oxide; and
a device in fluid communication with the gas source and comprising:
a first electrode;
an opposite second electrode comprising a catalytic material and an adsorption material, wherein the adsorption material is a perovskite material of formula AₐB_{b}O_{3-δ}, wherein 0.9<a≦1.2, 0.9<b≦1.2, −0.5<δ<0.5, A comprises a first element and optionally a second element, the first element is selected from calcium (Ca), strontium (Sr), barium (Ba), lithium (Li), sodium (Na), potassium (K), rubidium (Rb), and any combination thereof, the second element is selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and any combination thereof, and B is selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), zirconium (Zr), and any combination thereof;
an electrolyte between the first and the second electrodes; and
a power supply for applying an electrical current to the first and the second electrodes to remove nitrogen oxide.

5. The apparatus of claim 4, wherein the first element is selected from potassium (K), barium (Ba), strontium (Sr), and any combination thereof.

6. The apparatus of claim 4, wherein B is selected from yttrium (Y), cobalt (Co), cerium (Ce), zirconium (Zr), ferrum (Fe), and any combination thereof.

7. The apparatus of claim 4, wherein the first electrode is an anode and the second electrode is a cathode.

8. The apparatus of claim 1, wherein the second electrode comprises a layer comprising the catalytic material and the adsorption material.

9. The apparatus of claim 4, wherein the second electrode comprises a layer comprising the catalytic material and a layer comprising the adsorption material.

10. The apparatus of claim 4, wherein the adsorption material comprises BaZr_{0.1}Ce_{0.7}Y_{0.2}O₃, Ba_{0.5}Sr_{0.5}Co_{0.8}Fe_{0.2}O₃, Ba_{0.5}Sr_{0.4}K_{0.1}Co_{0.8}Fe_{0.2}O₃, Ba_{0.9}K_{0.1}Zr_{0.3}Ce_{0.5}Co_{0.1}Y_{0.1}O₃, or any combination thereof.

11. The apparatus of claim 4, wherein the gas source is an exhaust gas source.

12. The apparatus of claim 4, wherein the device is of a tubular configuration or a planar configuration.

13. A method for removing nitrogen oxide, comprising:
contacting a gas stream comprising nitrogen oxide with a device, the device comprising: a first electrode; an opposite second electrode comprising a catalytic material and an adsorption material; an electrolyte between the first and the second electrodes; and, a power supply; and
applying an electrical current from the power supply to the first and the second electrodes to remove nitrogen oxide; wherein
the adsorption material is a perovskite material of formula AₐB_{b}O_{3-δ}, wherein
0.9<a≦1.2;
0.9<b≦1.2;
−0.5<δ<0.5;
A comprises a first element and optionally a second element, the first element is selected from calcium (Ca), strontium (Sr), barium (Ba), lithium (Li), sodium (Na), potassium (K), rubidium (Rb), and any combination thereof, and the second element is selected from yttrium (Y), bismuth (Bi), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and any combination thereof; and
B is selected from silver (Ag), gold (Au), cadmium (Cd), cerium (Ce), cobalt (Co), chromium (Cr), copper (Cu), dysprosium (Dy), erbium (Er), europium (Eu), ferrum (Fe), gallium (Ga), gadolinium (Gd), hafnium (Hf), holmium (Ho), indium (In), iridium (Ir), lanthanum (La), lutetium (Lu), manganese (Mn), molybdenum (Mo), niobium (Nb), neodymium (Nd), nickel (Ni), osmium (Os), palladium (Pd), promethium (Pm), praseodymium (Pr), platinum (Pt), rhenium (Re), rhodium (Rh), ruthenium (Ru), antimony (Sb), scandium (Sc), samarium (Sm), tin (Sn), tantalum (Ta), terbium (Tb), technetium (Tc), titanium (Ti), thulium (Tm), vanadium (V), tungsten (W), yttrium (Y), ytterbium (Yb), zinc (Zn), zirconium (Zr), and any combination thereof.

14. The method of claim 13, wherein the first element is selected from potassium (K), barium (Ba), strontium (Sr), and any combination thereof.

15. The method of claim 13, wherein B is selected from yttrium (Y), cobalt (Co), cerium (Ce), zirconium (Zr), ferrum (Fe), and any combination thereof.

16. The method of claim 13, wherein the step of applying is at a temperature in a range of from 300° C. to 1000° C.

17. The method of claim 13, wherein the adsorption material adsorbs nitrogen oxide and the catalytic material catalyzes the decomposition of nitrogen oxide.

18. The method of claim 13, wherein the first electrode is an anode and the second electrode is a cathode.

19. The method of claim 13, wherein the first electrode comprises a material for catalyzing the oxidization of oxygen ions to oxygen.

20. The method of claim 13, wherein the adsorption material comprises BaZr_{0.1}Ce_{0.7}Y_{0.2}O₃, Ba_{0.5}Sr_{0.5}Co_{0.8}Fe_{0.2}O₃, Ba_{0.5}Sr_{0.4}K_{0.1}Co_{0.8}Fe_{0.2}O₃, Ba_{0.9}K_{0.1}Zr_{0.3}Ce_{0.5}Co_{0.1}Y_{0.1}O₃, or any combination thereof, and wherein the catalytic material comprises La_{0.6}Sr_{0.4}Ni_{0.3}Mn_{0.7}O₃.
